(19) United States
(12) Patent Application Publication
(10) Pub. No.: US 2023/0259947 A1
(43) Pub. Date: Aug. 17, 2023

(54) CHECKOUT APPARATUS AND METHOD

(71) Applicant: TOSHIBA TEC KABUSHIKI KAISHA, Tokyo (JP)

(72) Inventor: Hisashi MATSUKAWA, Mishima Shizuoka (JP)

(21) Appl. No.: 18/075,851

(22) Filed: Dec. 6, 2022

(30) Foreign Application Priority Data
Feb. 15, 2022 (JP) 2022-021596

(51) Int. Cl. G06Q 20/40; G06Q 20/20

(52) U.S. Cl. CPC G06Q 20/405; G06Q 20/4016; G06Q 20/20

(57) ABSTRACT

A checkout apparatus in one embodiment includes a control unit that causes a display unit to display a selection screen on which a payment method can be selected from a plurality of payment methods. The control unit receives privilege presence information from an input unit, such as a touch panel, barcode scanner, or the like. The privilege presence information indicates whether or not a customer intends to pay with a specific payment method with which a privilege is associated. If the received privilege presence information indicates the customer intends to pay with the specific payment method, the selection screen permits only the specific payment method to be selected.

### CROSS-REFERENCE TO RELATED APPLICATION

This application is based upon and claims the benefit of priority from Japanese Patent Application No. 2022-021596, filed Feb. 15, 2022, the entire contents of which are incorporated herein by reference.

### FIELD

Embodiments described herein relate to a checkout apparatus and a method performed by a checkout apparatus.

### BACKGROUND

In recent years, in a store that sells commodities and services (collectively referred to hereinafter as “products”), preferential services for certain customers have been provided. As a preferential service of this type, discounts and price-cuts might be provided to customers who are registered members of a company loyalty program, an employee of the store, or those customers who agree to use a specific payment method type, for example, electronic money or payment services managed by the company operating the store or the like.

If a price-cut is provided for a customer who uses the specific payment method, it is necessary to provide information related to the customer uses the specific payment method before calculating a transaction amount at before calculating a transaction amount at a checkout apparatus. This is because the transaction amount will be different depending on whether the user actually uses the specific payment method. On the other hand, in order to enable a customer to select a payment method amongst available methods in view of possible differences in the transaction amount (amount due), the checkout apparatus has to display different calculated transaction amounts before receiving the customer's payment method selection.

However, determining a customer-specific or payment method specific price-cut before the customer selects a payment method can still require information about the customer to be input to the checkout apparatus beforehand. In a conventional operation, the customer generally selects a payment method only after the standard calculated transaction amount has been displayed. If the checkout apparatus is a POS (Point of Sales) terminal operated by a store clerk, the clerk may make adjustments according to particularly selected payment methods and confirm any payment method corresponding to an applied price cut is actually used for settlement of the transaction.

However, if the checkout apparatus is operated by the customer himself or herself, a fraudulent act in which the customer may initially select a pay method associated with a price-cut but then perform actual settlement/payment using another payment method for which the price cut is not available. In this case, the price cut is applied in an incorrect or fraudulent manner and damage (revenue loss) occurs to the store.

### BRIEF DESCRIPTION OF THE DRAWINGS

FIG. 1 is a diagram illustrating an overview of a checkout system including a checkout apparatus.

FIG. 2 is a block diagram of a store server.

FIG. 3 is a diagram illustrating a data configuration of a transaction information unit.

FIG. 4 is a diagram illustrating a data configuration of a commodity master.

FIG. 5 is a block diagram of a control unit in a store server.

FIG. 6 is a block diagram of a checkout apparatus.

FIG. 7 is a diagram illustrating a data configuration of a privilege transaction information unit.

FIG. 8 is a block diagram of a control unit in a checkout apparatus.

FIG. 9 is a sequence chart illustrating an operation of a checkout system.

FIG. 10 is a flowchart illustrating a flow of payment processing.

FIG. 11 is a diagram illustrating an input screen for inputting privilege presence information or privilege absence information.

FIG. 12 is a diagram illustrating a guidance screen displayed by a checkout apparatus.

FIG. 13 is a diagram illustrating a transaction information display screen displayed by a checkout apparatus.

FIG. 14 is a diagram illustrating a first selection screen displayed by a checkout apparatus.

FIG. 15 is a diagram illustrating a second selection screen displayed by a checkout apparatus.

FIG. 16 is a diagram illustrating a fifth selection screen displayed by a checkout apparatus.

FIG. 17 is a diagram illustrating a third selection screen displayed by a checkout apparatus.

FIG. 18 is a diagram illustrating a fourth selection screen displayed by a checkout apparatus.

FIG. 19 is a flowchart illustrating a flow of payment processing by a control unit of a checkout apparatus.

FIG. 20 is a diagram illustrating an error message display screen displayed by a checkout apparatus.

FIG. 21 is a diagram illustrating a data configuration of a transaction information unit.

FIG. 22 is a sequence chart illustrating an operation of a checkout system.

### DETAILED DESCRIPTION

In general, according to one embodiment, a checkout apparatus and a program capable of suppressing a fraudulent act by the customer are provided.

According to one embodiment, a checkout apparatus includes a control unit. The control unit is configured to cause a display unit to display a selection screen on which a payment method can be selected from a plurality of payment methods. The control unit is also configured to receive privilege presence information from an input unit, which in some examples may be a touch screen, a scanner, or the like. The privilege presence information indicates whether or not a customer intends to pay with a specific payment method with which a privilege is associated. If the received privilege presence information indicates the customer intends to pay with the specific payment method, the selection screen permits only the specific payment method to be selected.

Checkout apparatuses, methods, and programs of certain example embodiments are explained below with reference to the drawings. Note that the disclosure is not limited by these example embodiments. A described example incorporates a portable terminal to which a customer inputs information concerning commodities being purchased by the customer. Such a portable terminal can be a smartphone carried by the customer. However, in other examples, the portable terminal may be a tablet terminal or the like provided by a store for in-store use by the customer. In an example, the described checkout apparatus does not specifically include a commodity registration function. That is, the checkout apparatus of the example is primary a settlement terminal, payment kiosk, or the like. However, in other examples, the checkout apparatus may incorporate or provide commodity registration functions in addition to the payment/settlement functions. In general, the checkout apparatus need only be a checkout apparatus with payment/settlement processing functions that can be operated by a customer alone without significant interaction with a store clerk or the like with respect to the payment/settlement functions. For example, the checkout apparatus may be a self-service POS terminal at which a customer performs both the operations relating to commodity registration and the checkout processing, a checkout apparatus of a semi-self-service POS system including a registration apparatus at which a store clerk performs the operations relating to commodity registration and a settlement terminal at which a customer performs operations relating to checkout processing (payment/settlement functions), or the like.

### First Embodiment

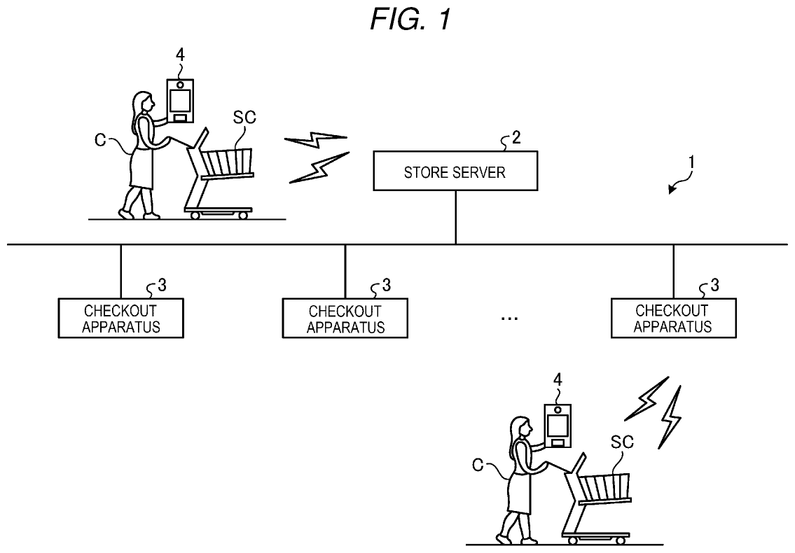

A checkout apparatus and a program in a first embodiment are explained below with reference to the drawings. FIG. 1 is a diagram illustrating an overview of a checkout system including a checkout apparatus. A checkout system 1 in this embodiment is applied to, for example, a supermarket. The checkout system 1 includes a store server 2, a plurality of checkout apparatuses 3, and a portable terminal 4. The figure depicts a shopping cart SC that is on a selling floor of a store and used by a customer C to carry commodities to be purchased.

The store server 2 and the checkout apparatuses 3 are communicably connected to each other via a network such as a LAN (Local Area Network). When an installed shopping application program (“shopping app”) is started on the portable terminal 4, the portable terminal 4 can connect to the store server 2 and the checkout apparatuses 3 via a wireless LAN or the like.

The store server 2 receives, from the checkout apparatuses 3, commodity information about commodities paid for in checkout processing and settlement information concerning a settlement method and the like. The store server 2 receives, from the checkout apparatuses 3, sales information indicating sales amounts in a predetermined period (for example, one day). The store server 2 centrally manages commodity information, settlement information, sales information, and the like received from the checkout apparatuses 3 and performs sales management (tracking) and the like of one store.

The store server 2 stores a commodity master listing commodities available for sale at the store. The commodity master has which commodity codes for each commodity type and stores commodity information (commodity names, prices, and the like) in association with the commodity codes. The store server 2 transmits commodity information (stored in the commodity master) to the portable terminal 4 in response to a request from the portable terminal 4. Further, the store server 2 transmits transaction information for a transaction to the checkout apparatus 3 in response to a request from the checkout apparatus 3.

The checkout apparatus 3 is, for example, a self-service type checkout apparatus at which the customer C performs operations relating to checkout processing by himself or herself. The checkout apparatus 3 reads a transaction code displayed on the portable terminal 4 and acquires transaction information relating to the transaction code from the store server 2. The checkout apparatus 3 executes, based on the acquired transaction information, checkout processing relating to payment by cash settlement or a cashless settlement such as credit settlement. The checkout processing is processing related to performing payment of the price of a commodity being purchased by the customer C.

A specific payment method associated with a grant of a preferential service to the customer C may be available to the customer C or such preferential service may not be available to the customer C. The checkout apparatus 3 can receive information indicating whether the preferential service is available (“privilege presence information”) or not available (“privilege absence information”). If the privilege presence information is received, the checkout apparatus 3 acquires the information relating to the particular privilege, such as a preferential price, from the store server 2 and executes the checkout processing based on the acquired information. In the following explanation, the specific payment method for which a privilege can be granted may be referred to as the “specific payment method” or the “privileged payment method.”

In this w, the privilege granted to the customer C is a service in which the customer C can purchase a particular commodity at a preferential price (discounted price). However, the privilege(s) granted to the customer C is not limited to this and the store can optionally select or set the possible privileges made available to particular customers. For example, the privilege granted to the customer C may be cutting a transaction amount by a fixed percentage without regard to particular commodities that are purchased by the customer C. In other examples, the privilege granted may relate to the provision of customer loyalty program points or the like which may be accumulated for various benefits or rewards in subsequent transactions.

In this embodiment, the specific payment method is a payment by electronic money managed by a company operating the store (hereinafter referred to as “payment by specific electronic money” as well). That is, the payment by the specific electronic money is an example of a specific payment method and is also an example of a payment method by a prepaid type medium. The payment by the specific electronic money is, for example, performed using an electronic money card, an application program linked with the electronic money card, or performed using a gift card. In general, the store can set the specific payment method to any arbitrary method. For example, the store can set the specific payment method to payment by cash.

The portable terminal 4 is, for example, a smartphone carried by the customer C. A shopping application program is installed in the portable terminal 4. If the shopping application program is started, the portable terminal 4 is communicably connected to the store server 2 and the checkout apparatuses 3 via a wireless LAN or the like.

The portable terminal 4 can realize the following functions by execution of the shopping application program. For example, the portable terminal 4 reads a commodity code from a code symbol attached to a commodity and acquires, from the store server 2, commodity information of the commodity identified by the commodity code. The portable terminal 4 acquires, from the store server 2, a transaction code for specifying one transaction (the current transaction), generates a barcode indicating the transaction code, and displays the barcode on a display unit of the device. Further, the portable terminal 4 communicates with the store server 2 and the checkout apparatuses 3 and executes other processing necessary for or related to shopping.

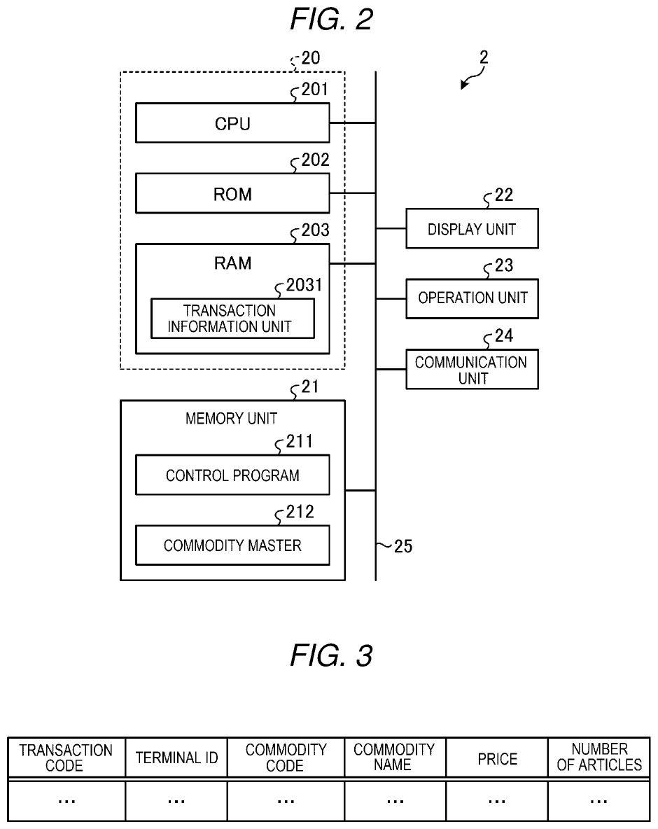

FIG. 2 is a block diagram illustrating a hardware configuration of the store server 2. The store server 2 includes a control unit 20, a memory unit 21, a display unit 22, an operation unit 23, and a communication unit 24. The control unit 20, the memory unit 21, the display unit 22, the operation unit 23, and the communication unit 24 are connected to one another via a bus 25 or the like.

The control unit 20 includes a CPU (Central Processing Unit) 201, a ROM (Read Only Memory) 202, and a RAM (Random Access Memory) 203. The CPU 201, the ROM 202, and the RAM 203 are connected to one another via the bus 25.

The CPU 201 controls an operation of the entire store server 2. The ROM 202 stores various programs such as a program used to drive the CPU 201 and various data. The RAM 203 is used as a work area of the CPU 201. Various programs and various data stored in the ROM 202 and the memory unit 21 can be loaded in the RAM 203. The CPU 201 operates according to a control program stored in the ROM 202 or the memory unit 21 and loaded in the RAM 203, whereby the control unit 20 executes various kinds of control processing for the store server 2.

The RAM 203 includes as a component thereof a transaction information unit 2031. In the transaction information unit 2031, transaction information associating information for identifying the portable terminal 4 and commodity information of a commodity to be purchased by the customer C (hereinafter referred to as “purchased commodity” as well) acquired from the portable terminal 4 during shopping of the customer C and information for specifying a transaction issued by the store server 2 is stored.

FIG. 3 is a diagram illustrating a data configuration of the transaction information unit 2031. Respective kinds of information indicating a transaction code, a terminal ID, a commodity code, a commodity name, a price, and the number of articles are associated with data registered in the transaction information unit 2031. The commodity code, the commodity name, the price, and the number of articles are together referred to as the commodity information of a purchased commodity.

The transaction code is issued by the control unit 20 when the control unit 20 receives a transaction information request from the portable terminal 4. The terminal ID for each portable terminal 4 may be set when the shopping application program is installed in the portable terminal 4. If there are plurality of different purchased commodities of the customer C in the same transaction, a plurality of commodity codes are registered in transaction information unit 2031 in association with same transaction code.

The name of the commodity is registered in the commodity name field. The unit price of the commodity is registered in the price field. Information indicating the number of articles of the same commodity being purchased is registered the number of articles field. In general, the commodity name and the price are read out from a commodity master 212 based on the commodity code acquired from the portable terminal 4 by the control unit 20. The price field value may be rewritten/adjusted according to information indicating a preferential price (if a preferential price is set for the purchased commodity) if the control unit 20 acquires privilege presence information from the checkout apparatus 3.

The memory unit 21 is a storage medium such as a HDD (Hard Disk Drive) or a flash memory and maintains storage content even if a power supply is shut off. The memory unit 21 stores a control program 211 and a commodity master 212.

The control program 211 is a program for realizing a function of performing sales management of the store, a function of transmitting commodity information to the portable terminal 4 in response to a request from the portable terminal 4, a function of transmitting transaction information to the checkout apparatus 3 in response to a request from the checkout apparatus 3, a function of transmitting transaction information based on a preferential price after price-cut to the checkout apparatus 3 if receiving privilege presence information from the checkout apparatus 3, and the like.

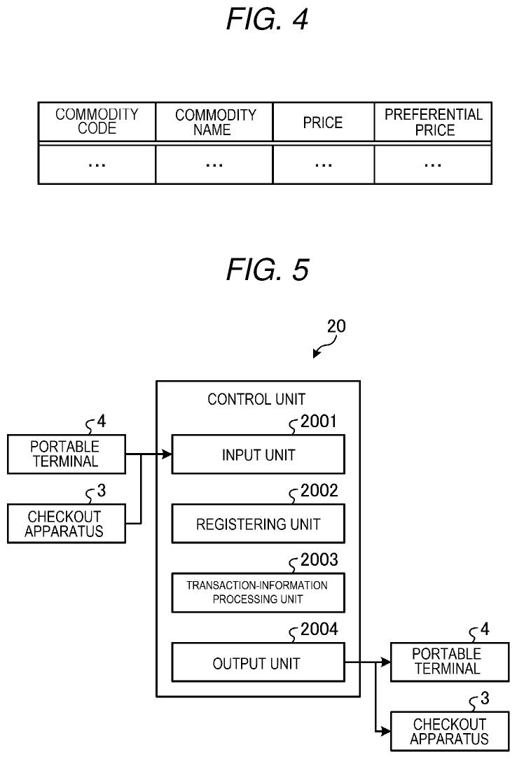

The commodity master 212 is a master file in which information about commodities sold in the store is stored. FIG. 4 is a diagram illustrating a data configuration of the commodity master 212. Various kinds of information indicating a commodity code, a commodity name, a price, and a preferential price are registered in the commodity master 212. Since the commodities sold in the store may change every day, the commodity master 212 can be updated as appropriate.

The commodity code is for identifying a commodity and may be referred to as commodity identification information. The commodity name provides a name of the commodity. The price is information indicating a unit price of the commodity. Information indicating a preferential price, that is, a price after a price-cut can be registered as an item in the preferential price field. Preferential prices may be set for all commodities or may be set for only some of the listed commodities. The information indicating the price and the preferential price may be a tax inclusive price including a consumption tax or may be a pre-tax price not including the consumption tax.

Referring back to FIG. 2, the hardware configuration of the store server 2 is explained. The display unit 22 is, for example, a liquid crystal panel and displays various kinds of information. For example, the display unit 22 displays a registration screen for registering the various kinds of information in the commodity master 212.

The operation unit 23 is allowing a user to input information to the control unit 20 and may be a keyboard, a touch panel provided on the surface of the display unit 22, or the like. For example, the operation unit 23 is used to provide various kinds of information to be registered in the commodity master 212.

The communication unit 24 is an interface for communicating with external apparatuses such as the checkout apparatus 3 and the portable terminal 4. The control unit 20 is connected to the external apparatuses via the communication unit 24 to be capable of transmitting and receiving information (data) to and from the external apparatuses.

FIG. 5 is a block diagram illustrating a functional configuration of the control unit 20 of the store server 2. The CPU 201 operates according to a control program stored in the ROM 202 or the memory unit 21, whereby the control unit 20 functions as an input unit 2001, a registering unit 2002, a transaction-information processing unit 2003, and an output unit 2004. These functions may be implemented or provided by hardware such as a dedicated circuit.

Various kinds of information are input to the input unit 2001 from the checkout apparatus 3, the portable terminal 4, and the like. For example, a commodity code read by the customer C with the portable terminal 4 during shopping and a terminal ID are input to the input unit 2001 from the portable terminal 4. If the customer C inputs a checkout instruction to the portable terminal 4, a transaction information request is input to the input unit 2001 from the portable terminal 4. Further, a transaction information request, privilege presence information, privilege absence information, or the like is input to the input unit 2001 from the checkout apparatus 3.

The registering unit 2002 registers information in the transaction information unit 2031. Specifically, the registering unit 2002 reads out, from the commodity master 212, commodity information corresponding to the commodity code input to the input unit 2001 from the portable terminal 4 and registers the commodity information in the transaction information unit 2031. If the transaction information request is input to the input unit 2001 from the portable terminal 4, the registering unit 2002 issues a transaction code and registers the transaction code in the transaction information unit 2031.

The transaction-information processing unit 2003 executes necessary processing concerning transaction information. For example, if the terminal ID and the transaction information request are input to the input unit 2001 from the portable terminal 4, the transaction-information processing unit 2003 reads out transaction information corresponding to the terminal ID from the transaction information unit 2031 and calculates a transaction amount. If the transaction code and the privilege presence information are input to the input unit 2001 from the checkout apparatus 3, the transaction-information processing unit 2003 reads out transaction information corresponding to the transaction code from the transaction information unit 2031 and checks whether a commodity for which a preferential price is set is present. If a commodity for which a preferential price is set is present, the transaction-information processing unit 2003 reads out the preferential price of the commodity from the commodity master 212 and rewrites an item of a price of the commodity in the transaction information unit 2031 into the preferential price. In addition, the transaction-information processing unit 2003 recalculates a transaction amount for the transaction based on the rewritten preferential price. Note that in some examples the calculation and the recalculation of the transaction amount may be performed by the checkout apparatus 3.

The output unit 2004 outputs various kinds of information to the checkout apparatus 3 and the portable terminal 4. For example, the output unit 2004 outputs, to the portable terminal 4, the transaction information extracted by the transaction-information processing unit 2003, the transaction amount calculated by the transaction-information processing unit 2003, and the transaction ID issued by the registering unit 2002. The output unit 2004 outputs, to the checkout apparatus 3, the transaction information written by the transaction-information processing unit 2003 and the transaction amount recalculated by the transaction-information processing unit 2003.

The store server 2 having the configuration explained above outputs, to the portable terminal 4 that reads a commodity code, commodity information of a commodity identified by the commodity code. Consequently, the customer C can check commodity information of a purchased commodity displayed on the portable terminal 4. The store server 2 outputs, to the checkout apparatus 3 to which the privilege presence information is input, commodity information of a commodity to which privilege granting is applied and a transaction amount to which the privilege granting is applied. Consequently, the customer C can view the commodity information and the transaction amount displayed on the checkout apparatus 3 and confirm that a privilege is granted, in other words, price-cut is performed.

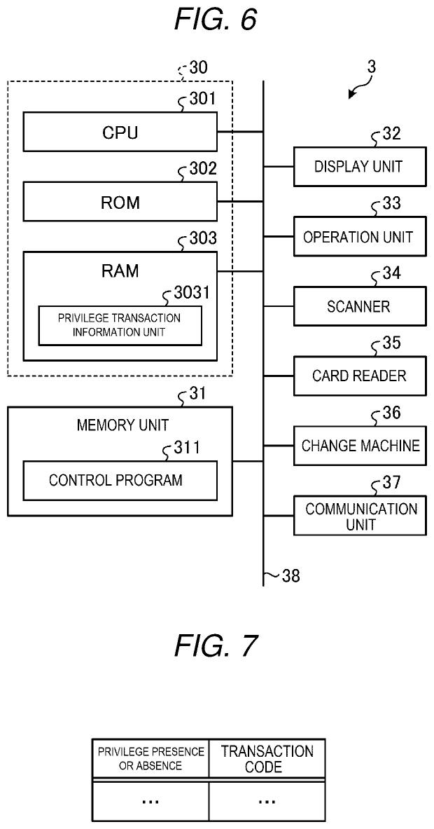

FIG. 6 is a block diagram illustrating a hardware configuration of the checkout apparatus 3. The checkout apparatus 3 includes a control unit 30, a memory unit 31, a display unit 32, an operation unit 33, a scanner 34, a card reader 35, a change machine 36, and a communication unit 37. The control unit 30, the memory unit 31, the display unit 32, the operation unit 33, the scanner 34, the card reader 35, the change machine 36, and the communication unit 37 are connected to one another via a bus 38 or the like.

The control unit 30 includes a CPU 301, a ROM 302, and a RAM 303. The CPU 301, the ROM 302, and the RAM 303 are connected to one another via the bus 38.

The CPU 301 controls an operation of the entire checkout apparatus 3. The ROM 302 stores various programs such as a program used to drive the CPU 301 and various data. The RAM 303 is used as a work area of the CPU 301. Various programs and various data stored in the ROM 302 and the memory unit 31 are loaded in the RAM 303. The CPU 301 operates according to a control program stored in the ROM 302 or the memory unit 31 and loaded in the RAM 303, whereby the control unit 30 executes various kinds of control processing for the checkout apparatus 3.

The RAM 303 includes a privilege transaction information unit 3031. In the privilege transaction information unit 3031, information indicating whether a transaction by the customer C is a target that receives privilege granting, in other words, privilege transaction information indicating whether the transaction by the customer C is paid by the specific payment method is stored.

FIG. 7 is a diagram illustrating a data configuration of the privilege transaction information unit 3031. Respective kinds of information indicating privilege presence or absence and a transaction code are associated with data registered in the privilege transaction information unit 3031.

In an item of the privilege presence or absence, information indicating whether a transaction specified by the transaction code corresponding to the privilege presence or absence is a target that receives privilege granting is registered. If privilege presence information is input to the control unit 30 from the operation unit 33, information indicating “privilege presence” is registered in the item of the privilege presence or absence. If privilege absence information is input to the control unit 30 from the operation unit 33, information indicating “privilege absence” is registered in the item of the privilege presence or absence. In an item of the transaction code, a transaction code for specifying one transaction is registered. The transaction code is a transaction code read by the scanner 34.

The memory unit 31 is c a storage medium such as a HDD or a flash memory and maintains stored content even if a power supply is shut off. The memory unit 31 stores a control program 311.

The control program 311 is, for example, a program for causing the display unit 22 to display various selection screens, such as a selection screen on which a payment method can be selected from a plurality of payment methods, for receiving an input of privilege presence information or privilege absence information, and the like.

The display unit 32 is, for example, a liquid crystal panel and displays various kinds of information. For example, the display unit 32 displays transaction information and a transaction amount acquired from the store server 2. The display unit 32 displays a selection screen for selecting a payment method for a purchase price. Further, the display unit 32 displays a selection screen for selecting privilege presence information or privilege absence information, that is, a selection screen for selecting whether payment by specific electronic money is used. The display unit 32 displays other various screens.

The operation unit 33 is for inputting information to the control unit 30 and may be a touch panel or the like provided on the surface of the display unit 32. The operation unit 33 is operated by the customer C to provide various kinds of information to the control unit 30. For example, the operation unit 33 provides the information associated with selections made on the various selection screens displayed on the display unit 32.

The scanner 34 reads, from a barcode displayed on the portable terminal 4 of the customer C, a transaction code for specifying a transaction. If the customer C performs payment by electronic money using a shopping application, the scanner 34 reads information necessary for the payment from a code symbol displayed on the portable terminal 4 of the customer C.

The card reader 35 reads credit information necessary for credit card settlement from a credit card of the customer C. If the customer C performs payment by an electronic money card or a gift card, the card reader 35 reads information necessary for the payment from the card.

When the customer C pays a purchase price by cash, the change machine 36 receives bills and coins paid by the customer C and dispenses change as necessary.

The communication unit 37 is an interface for communicating with external apparatuses, such as the store server 2 and the portable terminal 4. The control unit 30 is connected to these external apparatuses via the communication unit 37 to be capable of transmitting and receiving information (data) to and from the external apparatuses.

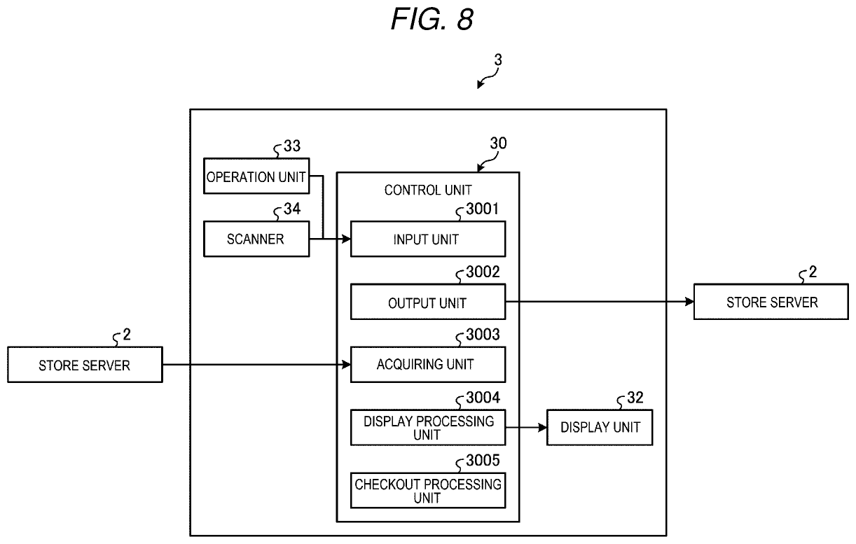

FIG. 8 is a block diagram illustrating a functional configuration of the control unit 30 of the checkout apparatus 3. The CPU 301 operates according to a control program stored in the ROM 302 or the memory unit 31, whereby the control unit 30 functions as an input unit 3001, an output unit 3002, an acquiring unit 3003, a display processing unit 3004, and a checkout processing unit 3005. These functions may be configured using hardware such as a dedicated circuit.

Privilege presence information indicating that the customer C performs payment with a specific payment method in which a privilege is granted to the customer C or privilege absence information indicating that the customer C performs payment with another payment method that is not the specific payment method is input to the input unit 3001. Specifically, information indicating whether payment by specific electronic money is performed by operation of the operation unit 33 is input to the input unit 3001. In some examples, the privilege presence information and/or the privilege absence information may be input from the portable terminal 4 rather than via the operation unit 33.

A transaction code read by the scanner 34 from a barcode displayed by the portable terminal 4 is input to the input unit 3001. Other various kinds of information are input to the input unit 3001. For example, information to the effect that checkout processing is started, information indicating a payment method selected by the customer C, and the like can be input to the input unit 3001 from the operation unit 33.

The output unit 3002 outputs various kinds of information. For example, if the transaction code and the privilege presence information are input to the input unit 3001, the output unit 3002 outputs a transaction information request to the store server 2 together with the transaction code and the privilege presence information. If the transaction code and the privilege absence information are input to the input unit 3001, the output unit 3002 outputs a transaction information request to the store server 2 together with the transaction code and the privilege absence information.

The acquiring unit 3003 acquires transaction information of a transaction on condition that the privilege presence information or the privilege absence information has already been input to the input unit 3001. Specifically, the acquiring unit 3003 acquires transaction information output by the store server 2 in response to the transaction information request output by the output unit 3002 only after the privilege presence information or the privilege absence information has been input to the input unit 3001. Note that in some examples the acquiring unit 3003 may acquire transaction information from the portable terminal 4. In this case, if the privilege presence information is input to the input unit 3001, a transaction amount may be recalculated by the checkout apparatus 3.

The display processing unit 3004 causes the display unit 32 to display a selection screen on which any payment method can be selected from a plurality of payment methods. If the privilege presence information is input to the input unit 3001, the display processing unit 3004 displays a selection screen on which only a specific payment method can be selected. For example, if the privilege presence information is input to the input unit 3001, the display processing unit 3004 grays out, on a selection screen on which a payment method can be selected, an icon for selecting a payment method other than the specific payment method. Alternatively, if the privilege presence information is input to the input unit 3001, for example, the display processing unit 3004 may display, on the selection screen on which a payment method can be selected, only an icon for selecting the specific payment method.

The display processing unit 3004 causes the display unit 32 to display an input screen for inputting the privilege presence information or the privilege absence information. Specifically, if information to the effect that checkout processing is started is input to the input unit 3001, the display processing unit 3004 causes the display unit 32 to display an input screen for inputting whether to perform payment by specific electronic money.

The checkout processing unit 3005 executes the checkout processing based on the transaction information acquired by the acquiring unit 3003. The checkout processing is processing for the customer C to perform payment of a purchase price. In the case of payment by cash, the checkout processing includes processing for calculating and displaying change and processing for instructing a change machine to dispense the change. In the case of cashless settlement by electronic money, a credit card, or the like, the checkout processing includes communication with a settlement server for completing settlement.

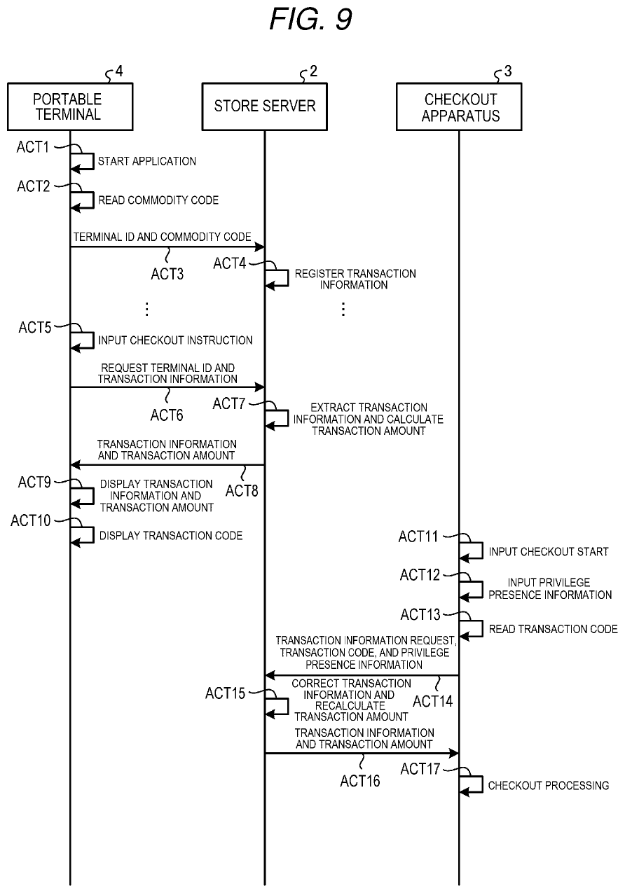

An overview of an operation of the checkout system 1 having the configuration described above is explained. FIG. 9 is a sequence chart illustrating the operation of the checkout system 1. The sequence chart illustrates an operation in the case in which a specific payment method is selected, that is, in the case in which privilege presence information is input.

If the customer C performs shopping in the store, the portable terminal 4 starts a shopping application program according to operation of the customer C or according to, for example, detection of the portable terminal 4 being located in the store (ACT1). The portable terminal 4 reads a commodity code of a purchased commodity using a camera or the like included in the own device (ACT2). The portable terminal 4 transmits (outputs) a terminal ID for identifying the own device and the read commodity code to the store server 2 (ACT3).

The store server 2 registers transaction information in the transaction information unit 2031 based on the received terminal ID and the received commodity code (ACT4). More specifically, the store server 2 reads out, from the commodity master 212, commodity information corresponding to the received commodity code. The store server 2 registers the received terminal ID and the read-out commodity information in the transaction information unit 2031 in association with each other. In some examples, that commodity registration for registering the commodity information performed in ACT4 may be performed by the portable terminal 4.

The processing in ACT2 to ACT4 is performed every time a commodity code is read by the portable terminal 4. If reading of commodity codes is completed for all commodities to be purchased by the customer C, a checkout instruction input is made to the portable terminal 4 (ACT5). When the checkout instruction input is performed, the portable terminal 4 transmits the terminal ID and a transaction information request to the store server 2 (ACT6).

The store server 2 refers to the transaction information unit 2031, extracts transaction information corresponding to the terminal ID received from the portable terminal 4, and calculates a total amount due (transaction amount) reflecting the purchase prices of the registered commodities based on the transaction information (ACT7). At this time, the store server 2 issues a transaction code and registers the transaction code in the transaction information unit 2031. The store server 2 then transmits the transaction information including the transaction code and the calculated transaction amount to the portable terminal 4 (ACT8).

The portable terminal 4 displays the received transaction information and the received transaction amount (ACT9). The displayed transaction information is commodity information included in the transaction information. The portable terminal 4 converts the transaction code into a barcode and displays the barcode (ACT10). The barcode indicating the transaction code can be displayed on a display screen on which the transaction information is also displayed or a separate display screen.

The customer C moves to the checkout apparatus 3 and begins to perform payment operations at the checkout apparatus 3. In the payment operation (checkout process), a checkout start input is made on the checkout apparatus 3 (ACT11). If the customer C intends to use the privileged payment method, the privilege presence information is first input to the checkout apparatus 3 (ACT12). The checkout apparatus 3 then read the transaction code from the barcode displayed on the portable terminal 4 (ACT13). The checkout apparatus 3 transmits a transaction information request to the store server 2 together with the privilege presence information and the transaction code (ACT14).

The store server 2 extracts, from the transaction information unit 2031, the transaction information corresponding to the received transaction code and, if commodity information of a commodity for which a preferential price is set is included in the transaction information, corrects the transaction information and recalculates the transaction amount (amount due) (ACT15). Specifically, the store server 2 adjusts the price corresponding to the commodity for which the preferential price is set to the new price (preferential price) and calculates the transaction amount accordingly based on revised price(s). The store server 2 then transmits the corrected transaction information and the recalculated transaction amount to the checkout apparatus 3 (ACT16).

The checkout apparatus 3 executes checkout processing based on the received transaction information and the received transaction amount (ACT17). Consequently, a privilege (e.g., a price cut) is granted to the customer C in this transaction.

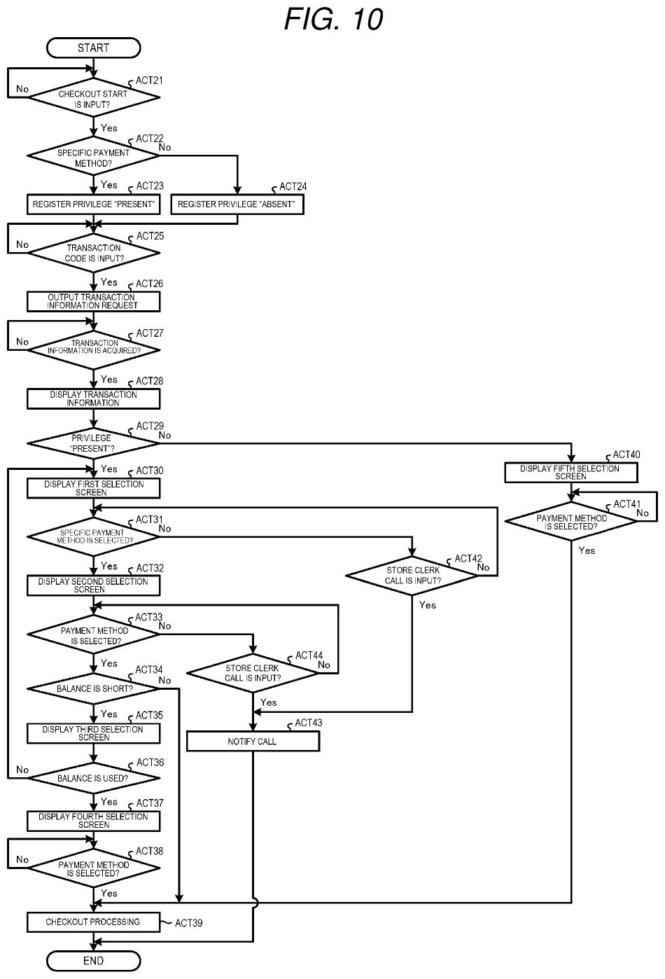

FIG. 10 is a flowchart illustrating a flow of the payment processing by the control unit 30 of the checkout apparatus 3.

First, the control unit 30 determines whether a checkout start input is made to the input unit 3001 (ACT21) and, if the checkout start input is not performed (N in ACT21), returns to the processing in ACT21 and stays on standby.

If the checkout start input is made to the input unit 2001 (Y in ACT21), the control unit 30 determines whether the specific payment method, that is, payment by specific electronic money is selected by the customer C (ACT22). Specifically, the control unit 30 determines whether the privilege presence information is input to the input unit 3001 by operation of the customer C.

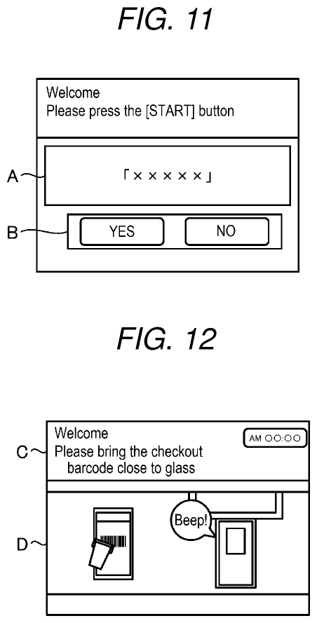

FIG. 11 depicts an input screen for inputting whether to perform payment with the specific payment method. That is, a selection screen illustrated in FIG. 11 is an example of an input screen for inputting the privilege presence information or privilege absence information. A message display section A and a selection button display section B are formed on the input screen.

In the message display section A, a message such as “Do you pay by a xx card, a xx application, or a xx gift card? If you pay by the xx card, the xx application, or the xx gift card, xx brand commodities are price-cut” is displayed. In the selection button display section B, a “YES” button and a “NO” button are displayed. If the “YES” button is operated, the payment by the specific electronic money, which is the specific payment method, is selected and the privilege presence information is input to the control unit 30. If the “NO” button is operated, the payment by the specific electronic money is not selected and the privilege absence information is input to the control unit 30.

Referring back to FIG. 10, if the specific payment method is selected (Y in ACT22), in other words, if the “YES” button in FIG. 11 is operated, the control unit 30 registers this as privilege “present” in the privilege transaction information unit 3031 (ACT23). On the other hand, if the specific payment method is not selected (N in ACT22), in other words, if the “NO” button in FIG. 11 is operated, the control unit 30 registers this as privilege “absent” in the privilege transaction information unit 3031 (ACT24).

The control unit 30 then determines whether a transaction code has been input to the input unit 3001 from the scanner 34 (ACT25). In other words, the control unit 30 determines whether the scanner 34 has read a barcode displayed on the portable terminal 4 of the customer C.

FIG. 12 is a diagram illustrating a guidance screen for guiding the customer C to read a transaction code. A character display section C and an illustration display section D are formed on the guidance screen. Operation for causing the scanner 34 to read the barcode displayed on the portable terminal 4 is guided by the character display section C and the illustration display section D.

Referring back to FIG. 10, if a transaction code is not input to the input unit 3001 (N in ACT25), the control unit 30 returns to the processing in ACT25 and stays on standby. If a transaction code is input to the input unit 3001 (Y in ACT25), the output unit 3002 outputs a transaction information request to the store server 2 together with the transaction code (ACT26). If privilege “present” is registered corresponding to the transaction code, that is, if the specific payment method is to be selected by the customer C, the output unit 3002 outputs the privilege presence information as well. If privilege “absent” is registered, the output unit 3002 outputs the privilege absence information together with the transaction information request.

Subsequently, the control unit 30 determines whether the acquiring unit 3003 has acquired transaction information from the store server 2 (ACT27) and, if not (N in ACT27), the control unit 30 returns to the processing in ACT27 and stays on standby. If yes (Y in ACT27), the display processing unit 3004 displays a transaction information display screen on the display unit 32 (ACT28).

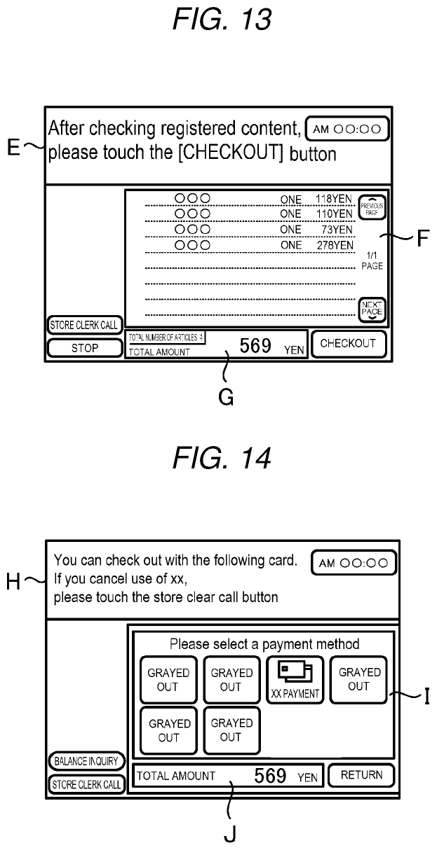

FIG. 13 is a diagram illustrating the transaction information display screen. A message display section E, a commodity information display section F, and a transaction amount display section G are formed on the transaction information display screen. A button for calling a store clerk, a button for stopping a transaction, and a button for shifting to checkout processing are also displayed on the transaction information display screen.

The message display section E displays a message for guiding the customer C about operation. The commodity information display section F displays commodity information included in the transaction information, more specifically, a commodity name, the number of articles, and a price. The transaction amount display section G displays a transaction amount, that is, a total amount for purchased commodities.

Referring back to FIG. 10, if the button for shifting to the checkout processing in FIG. 13 is operated, the control unit 30 determines whether the privilege “present” is registered in the item of the privilege presence or absence of the privilege transaction information unit 3031 (ACT29). If the privilege “present” is registered (Y in ACT29), that is, if the specific payment method is selected by the customer C, the display processing unit 3004 causes the display unit 32 to display a first selection screen (ACT30).

FIG. 14 is a diagram illustrating the first selection screen. A message display section H, a payment method selection section I, and a transaction amount display section J are formed on the first selection screen. A button for checking the balance of electronic money, a button for calling a store clerk, and a button for returning to the pervious screen are also displayed on the first selection screen.

The message display section H displays a message for guiding the customer C about operation. The payment method selection section I displays a plurality of icons for a customer to select a payment method. However, the icons for other than the icon for selecting the payment by the specific electronic money are grayed out. Even if the operator C selects (or attempts to select) one of the grayed out icons, information is not sent to the control unit 30. Consequently, payment by the specific payment method is more surely performed. Therefore, it is possible to prevent a fraudulent act of receiving a privilege without actually using the required specific payment method. The transaction amount display section J displays a transaction amount. The first selection screen illustrated in FIG. 14 is an example of a selection screen on which only the specific payment method can be selected if the privilege presence information has been input to the input unit 3001.

Referring back to FIG. 10, the control unit 30 determines whether the specific payment method (the payment by the specific electronic money) is selected (ACT31). If the specific payment method is selected (Y in ACT31), in other words, if an icon not grayed out is operated on the first selection screen illustrated in FIG. 14, the display processing unit 3004 causes the display unit 32 to display a second selection screen (ACT32).

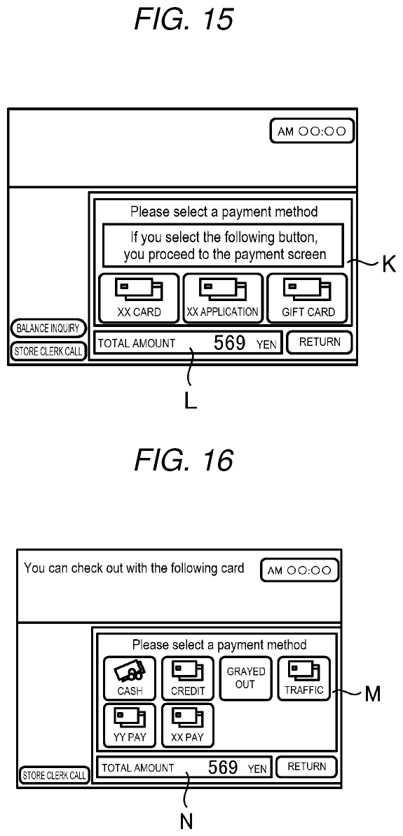

FIG. 15 is a diagram illustrating the second selection screen. A payment method selection section K and a transaction amount display section L are formed on the second selection screen. Same as on the first selection screen, a button for collating the balance of electronic money, a button for calling a store clerk, and a button for returning to the previous screen are also displayed on the second selection screen.

The payment method selection section K displays a plurality of icons for performing the payment by the specific electronic money. In other words, all of the icons displayed in the payment method selection section K correspond to the specific payment method. More specifically, in the payment method selection section K, an icon for performing payment using an electronic money card, an icon for performing payment using an application program linked with the electronic money card, and an icon for performing payment using a gift card are displayed. The transaction amount display section L displays a transaction amount.

Referring back to FIG. 10, the control unit 30 determines whether any payment method is selected (ACT33). If a payment method is selected (Y in ACT31), in other words, if any icon illustrated in FIG. 15 is operated, the control unit 30 determines whether the balance of the electronic money is short (ACT34). For example, based on information concerning an electronic money card read by the card reader 35, the control unit 30 communicates with an electronic money server for managing the balance, checks the balance, and determines whether the balance is short. If the balance of the electronic money is short (Y in ACT34), the display processing unit 3004 causes the display unit 32 to display a third selection screen (ACT35).

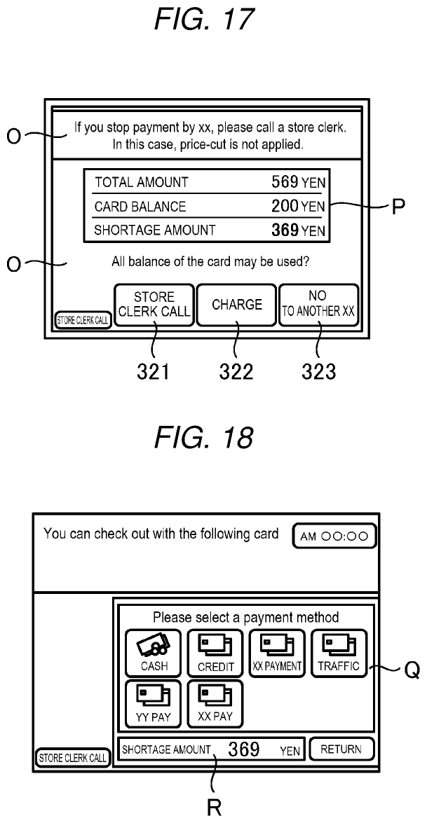

FIG. 17 is a diagram illustrating the third selection screen. A message display section O and a shortage information display section P are formed on the third selection screen. A button for calling a store clerk and a plurality of buttons 321 to 323 are also displayed on the third selection screen.

The message display section O displays a message indicating that it is necessary to call a store clerk if the payment by the specific electronic money is stopped, a message indicating that a privilege is not received if the payment by the specific electronic money is stopped, a message for checking whether all the balance of the electronic money may be used, and the like. The shortage information display section P displays a total amount (a transaction amount), a card balance (the balance of the electronic money), and a shortage amount. The third selection screen illustrated in FIG. 17 is an example of a screen on which a message indicating that a privilege is not granted by a payment method is displayed if the balance of the electronic money is short with respect to the present transaction amount.

The button 321 to indicate that all the card balance may be used. If the button 321 is operated, the third selection screen shifts to a fourth selection screen. The button 322 is for charging cash on the electronic money card. If the button 322 is operated, the third selection screen shifts to a screen for charging. The button 323 is for indicating another payment method, for example, a gift card or an application program linked to specific electronic money is to be performed. If the button 323 is operated, the third selection screen shifts to the first election screen. In some examples, the third selection screen may shift to the second selection screen if the button 323 is operated. For stopping/cancelling the payment by the specific electronic money, the customer C operates the store clerk call button.

Referring back to FIG. 10, the control unit 30 determines whether the balance of the electronic money is to be used based received input (ACT36). In other words, the control unit 30 determines whether the button 321 has been operated on the third selection screen illustrated in FIG. 17. If the balance of the electronic money is to be used is (Y in ACT36), the display processing unit 3004 causes the display unit 32 to display a fourth selection screen (ACT37).

FIG. 18 is a diagram illustrating the fourth selection screen. A payment method selection section Q and a shortage amount display section R are formed on the fourth selection screen. A button for calling a store clerk and a button for returning to the previous screen are also displayed on the fourth selection screen.

The payment method selection section Q displays a plurality of icons indicating payment methods selectable by the customer C. On the first selection screen illustrated in FIG. 14, the icons other than the icon for the specific electronic money are grayed out. However, all the icons are selectable on the fourth selection screen. This enables the customer C to receive a privilege even if part of the full transaction amount is paid by another payment method since at least a part of a transaction amount was paid with the specific electronic money. In other examples, the privilege may be conditional on the full transaction amount being paid by the specific electronic money. The shortage amount display section R displays a shortage amount of the electronic money.

Referring back to FIG. 10, the control unit 30 determines whether a payment method has been selected for the shortage amount (ACT38). In other words, the control unit 30 determines whether another icon has been operated (selected) on the fourth selection screen illustrated in FIG. 18. If a payment method is not yet selected (N in ACT38), the control unit 30 returns to the processing in ACT38 and stays on standby.

If a payment method is selected (Y in ACT38), the checkout processing unit 3005 executes the checkout processing (ACT39). The control unit 30 ends the payment processing.

When the privilege “absent” is registered in the processing in ACT29 (N in ACT29), the display processing unit 3004 causes the display unit 32 to display a fifth selection screen (ACT40).

FIG. 16 is a diagram illustrating the fifth selection screen. A payment method selection section M and a transaction amount display section N are formed on the fifth selection screen. A button for calling a store clerk and a button for returning to the previous screen are also displayed on the fifth selection screen.

Like the payment method selection section I of the first selection screen illustrated in FIG. 14, the payment method selection section M displays a plurality of icons for a customer to select a payment method. However, contrary to the payment method selection section I, only an icon for selecting the payment by the specific electronic money is grayed out and the other icons are not grayed out. Consequently, even if the customer C operates the icon for selecting the payment by the specific electronic money, information is not input to the control unit 30. The transaction amount display section G displays a transaction amount.

Referring back to FIG. 10, the control unit 30 determines whether a payment method is selected (ACT41). In other words, the control unit 30 determines whether any one of the icons not grayed out is operated on the fifth selection screen illustrated in FIG. 16.

If a payment method is not selected (N in ACT41), the control unit 30 returns to the processing in ACT41 and stays on standby. If a payment method is selected (Y in ACT41), the control unit 30 shifts to the processing in ACT39.

If the specific payment method is not selected in the processing in ACT31 (N in ACT31), the control unit 30 determines whether a store clerk call is input to the input unit 3001 (ACT42). That is, the control unit 30 determines whether the customer C calls a store clerk in order to stop the payment by the specific electronic money.

If the store clerk call input is not performed (N in ACT42), the control unit 30 returns to the processing in ACT31. If the store clerk call input is performed (Y in ACT42), the control unit 30 performs call notification processing (ACT43). The call notification processing is processing for calling a store clerk and is executed by, for example, lighting a lighting unit (lamp) provided in the checkout apparatus 3 or sending a call notification to a terminal device carried or monitored by the store clerk. Then, the control unit 30 ends the payment processing. In this case, the operations for stopping the payment by the specific electronic money and permitting the customer C to perform payment by another payment method is performed by inputs from the called store clerk.

If a payment method is not selected in the processing in ACT33 (N in ACT33), the control unit 30 determines whether a store clerk call was input to the input unit 3001 (ACT44). Same as in the processing in ACT42, the control unit 30 determines whether the customer C calls a store clerk in order to stop the payment by the specific electronic money.

If the store clerk call input is not performed (N in ACT44), the control unit 30 returns to the processing in ACT33. If the store clerk call input is performed (Y in ACT44), the control unit 30 shifts to the processing in ACT43.

According to the payment processing, the customer C can receive a privilege (e.g., price cut) if the customer C selects the specific payment method (the privileged payment method). Since after the specific payment method is selected by the customer C, the payment must be performed by the privileged payment method (or else a clerk must be called), it is possible to suppress a fraudulent act by the customer.

As explained above, the checkout apparatus in the first embodiment is a checkout apparatus 3 that executes checkout processing for the customer C permitting the customer C to make a payment relating to a transaction. The checkout apparatus 3 includes a display processing unit 3004 that causes the display unit 32 to display a selection screen (the fifth selection screen) on which a payment method can be selected from among a plurality of available payment methods and an input unit 3001 to which privilege presence information can be input. If the privilege presence information is input to the input unit 3001, the display processing unit 3004 displays a selection screen (the first selection screen) on which only the specific payment method can actually be selected.

Consequently, if the customer C selects a privileged payment method with which a privilege/benefit is associated, it is possible to make sure that transaction payment is actually performed using the selected privileged payment method. Therefore, it is possible to suppress a fraudulent act of a customer C who might otherwise make payment using another (non-privileged) method after previously selecting (or otherwise indicating an intention to use) the privileged payment method.

### Second Embodiment

The second embodiment is different from the first embodiment in that, if a payment method other than the specific payment method is selected by the customer C after privilege presence information has been input, an error message is displayed. In the following explanation, those aspects substantially similar to the first embodiment may be omitted from specific description of the second embodiment which focus primarily on differences between the embodiments.

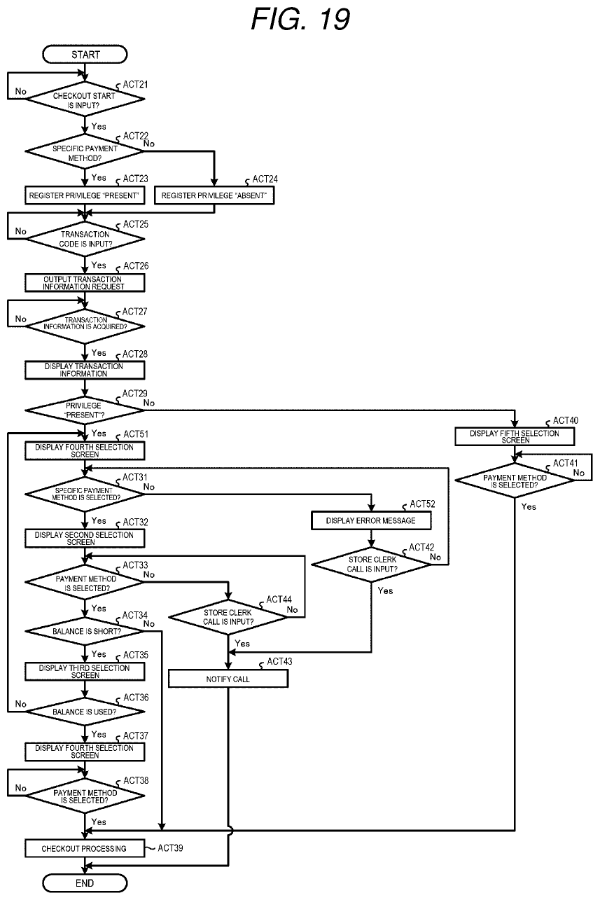

FIG. 19 is a flowchart illustrating a flow of payment processing in the control unit 20 of the checkout apparatus 3 in the second embodiment. Processing in ACT21 to ACT29 is the same as in the first embodiment.

If privilege “present” is registered in the processing in ACT29 (Y in ACT29), the display processing unit 3004 causes the display unit 32 to display the fourth selection screen illustrated in FIG. 18 (ACT51). That is, the display processing unit 3004 causes the display unit 32 to display a selection screen on which any of the available payment methods might be selected even though the privilege presence information has been input.

If the privileged payment method (“xx payment” in FIG. 18) is selected on the fourth selection screen (Y in ACT31), the processing in ACT32 is executed. If a payment method other than the privileged payment method is selected on the fourth selection screen (N in ACT31), the display processing unit 3004 causes the display unit 32 to display an error message display screen (ACT52).

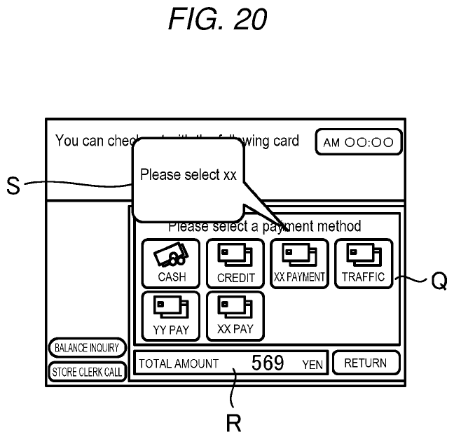

FIG. 20 is a diagram illustrating the error message display screen. In the error message display screen, an error message S is displayed on the fourth selection screen. That is, if the customer C selects a payment method other than the privileged payment method on the fourth selection screen, the error message S is popup-displayed. When the customer C selects an icon of a payment method other than the privileged payment method, the control unit 30 does not receive (or otherwise treats such a selection as invalid) input information based on the operation. The control unit 30 executes the processing in ACT42.

According to the payment processing in this second embodiment, the customer C can receive a privilege if the customer C selects the privileged payment method. If an operation for executing another payment method is performed although privilege presence information has been input by the customer C, the checkout apparatus 3 performs display for urging payment via the privileged payment method and does not execute any other payment method at this time. Therefore, changing of payment method from a privileged payment method to another (unprivileged) payment method can not be performed by the customer C after an associated privilege has been provided/applied to the transaction, thus it is possible to suppress a fraudulent act by the customer.

The checkout apparatus 3 in the second embodiment is the checkout apparatus 3 that executes checkout processing for the customer C to perform payment relating to a transaction. The checkout apparatus 3 includes a display processing unit 3004 that causes the display unit 32 to display a selection screen (the fifth selection screen) on which a payment method can be selected from a plurality of payment methods and a input unit 3001 to which privilege presence information indicating that the customer C intends to perform payment with a specific (privileged) payment method can be input. If the privilege presence information is input to the input unit 3001, the display processing unit 3004 displays an error message S if a payment method that is not the privileged payment method is ultimately selected by the customer C even though privilege presence information has been input.

Consequently, as in the first embodiment, it is possible to suppress a fraudulent act of the customer C who might make a payment with another method after previously selecting (or otherwise indicating an intention to use) the privileged payment method.

The display processing unit 3004 of the checkout apparatus 3 in the first embodiment and the second embodiment causes the display unit 32 to display the input screen for inputting privilege presence information or privilege absence information.

Consequently, the customer C can input the privilege presence information or the privilege absence information when paying a purchase price. Therefore, since the input can be performed in the same operation as performing payment at the checkout apparatus 3, the operation is easy to perform for the customer C.

### Third Embodiment

The third embodiment is different from the first embodiment and the second embodiment in that the privilege presence information can be input from the portable terminal 4. In the following explanation, aspects the which are the same as in the first embodiment will generally not be described again so that a focus on differences between embodiments is provided.

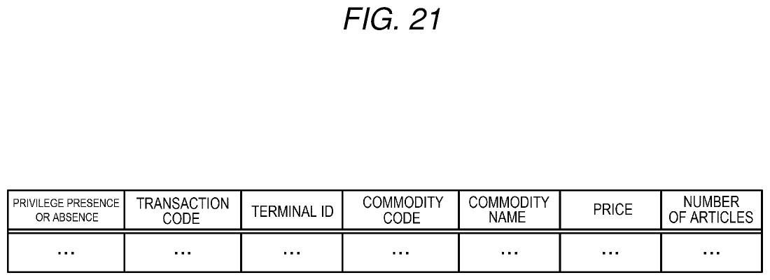

FIG. 21 is a diagram illustrating a data configuration of the transaction information unit 2031 included in the RAM 203 of the store server 2 in the third embodiment. Information indicating privilege presence or absence is also registered in the transaction information unit 2031 in association with a transaction code and the like. The information indicating the privilege presence or absence can be registered based on information received from the portable terminal 4.

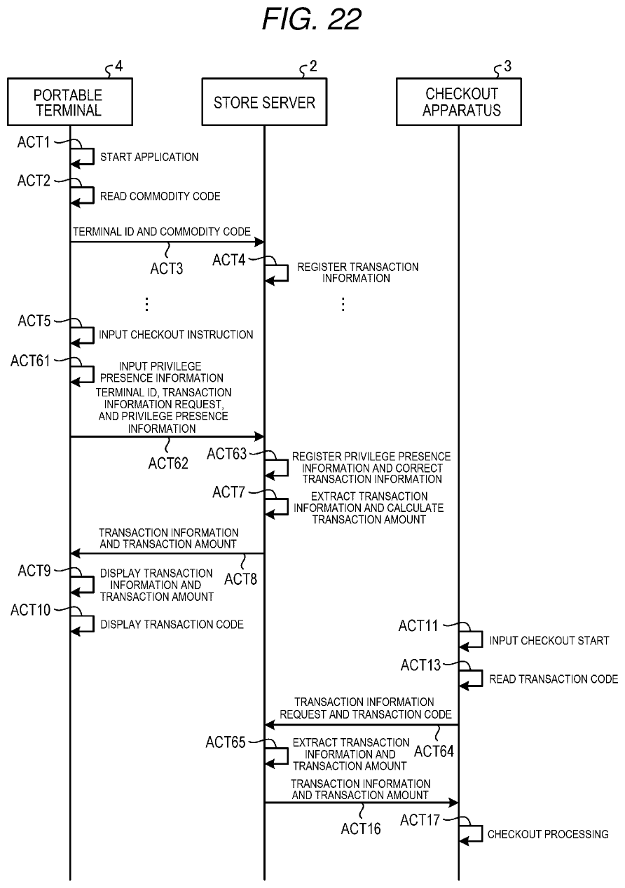

FIG. 22 is a sequence chart illustrating the operation of the checkout system 1 in the third embodiment. The sequence chart illustrates an operation when the privilege presence information is input as in the example explained in conjunction with FIG. 9. The processing in ACT1 to ACT5 is the same as the processing in the first embodiment.

If the privileged payment method is selected by operation of the customer C and the privilege presence information has been input to the portable terminal 4 (ACT61), the portable terminal 4 transmits the terminal ID, the transaction information request, and the privilege presence information to the store server 2 (ACT62).

The store server 2 registers the privilege presence information in the transaction information associated with the received terminal ID and updates the transaction information as necessary (ACT63). Specifically, if a commodity for which a preferential price is set among the commodities stored in the transaction information unit 2031 is present, the store server 2 changes the price corresponding to the commodity to the preferential price. At this time, the store server 2 issues a transaction code and registers the transaction code in the transaction information unit 2031.

When the privilege absence information is input from the portable terminal 4, the store server 2 registers the privilege absence information in the transaction information unit 2031 and does not need to perform any correction of the transaction information. The processing in ACTT to ACT13 is the same as the processing in the first embodiment.

Upon reading a transaction code from the portable terminal 4 (ACT13), the checkout apparatus 3 transmits the transaction code and the transaction information request to the store server 2 (ACT64). The store server 2 extracts transaction information and a transaction amount based on the received transaction code (ACT65). The subsequent processing is the same as the processing in the first embodiment.

As explained above, according to the third embodiment, the customer C can input the privilege presence information with the portable terminal 4. Accordingly, operation time of the customer C at the checkout apparatus 3 can be reduced. Therefore, according to the third embodiment, it is possible to achieve efficiency of customer management of the checkout apparatus 3 in addition to suppressing a fraudulent act by the customer C. The customer C can also check the preferential price using the portable terminal 4.

In each above-described embodiment, the privilege absence information indicating that the customer C intends to perform payment with a payment method that is not the privileged payment method can be input to the input unit 3001. The checkout apparatus 3 further includes the acquiring unit 3003 that may acquire transaction information on condition that the privilege presence information or the privilege absence information has already been input to the input unit 3001 and thus the checkout processing unit 3005 that executes the checkout processing based on the transaction information acquired by the acquiring unit 3003 may be prevented from performing the checkout processing until the privilege presence/absence information has been provided.

Consequently, the checkout apparatus 3 can acquire transaction information that either reflects the application of the associated privileged or not as appropriate. For example, if the privilege presence information is input after transaction information is acquired, the checkout apparatus 3 would need to reacquire (or recalculate) transaction information with the privilege applied thereto. However, with the checkout apparatus 3 of the present disclosure, such reacquisition of the transaction information does not occur and smoother checkout processing is possible.

If the balance of a prepaid type electronic money is short with respect to a transaction amount, the display processing unit 3004 of the checkout apparatus 3 displays a message indicating that a privilege is not granted.

Consequently, the checkout apparatus 3 can cause the customer C to recognize that a privilege is not granted if the customer C changes the specific payment method to another payment method when the balance of the privileged electronic money payment method is short. Accordingly, it is possible to prevent a trouble that could occur between the store and the customer C.

In an example, control programs executed by the store server 2, the checkout apparatus 3, and the portable terminal 4 may be recorded in a non-transitory, computer-readable recording medium such as a CD-ROM or stored on a computer connected to a network such as the Internet and provided by being downloaded or otherwise accessed through the network.

While certain embodiments have been described, these embodiments are presented by way of example only, and are not intended to limit the scope of the present disclosure. The novel embodiments can be implemented in various other forms and various omissions, substitutions and modifications can be made without departing from the spirit of the present disclosure. Such embodiments and modifications thereof are included in the scope and spirit of the disclosure, and are included in the claims and equivalents of thereof.

What is claimed is:

1. A checkout apparatus, comprising:
a control unit configured to:
cause a display unit to display a selection screen on which a payment method can be selected from a plurality of payment methods; and
receive privilege presence information from an input unit, the privilege presence information indicating whether or not a customer intends to pay with a specific payment method with which a privilege is associated, wherein
if the received privilege presence information indicates the customer intends to pay with the specific payment method, the selection screen permits only the specific payment method to be selected.

2. The checkout apparatus according to claim 1, wherein icons for payments methods other than the specific payment method are grayed out on the selection screen when the received privilege presence information indicates the customer intends to pay with the specific payment method.

3. The checkout apparatus according to claim 1, wherein the control unit is configured to cause the display unit to display an error message if the received privilege presence information indicates the customer intends to pay with the specific payment method and any other payment method other than the specific payment method is selected on the selection screen.

4. The checkout apparatus according to claim 1, wherein
the input unit is a scanner, and
the privilege presence information is provided via the scanner scanning a code.

5. The checkout apparatus according to claim 1, wherein
the input unit is a touch panel integrated with the display unit,
the control unit is further configured to display a privileged payment method intention screen on the display unit before the selection screen, and
the customer provides the privilege presence information via the touch panel while the privileged payment method intention screen is displayed.

6. A checkout apparatus, comprising:
a display screen for displaying information to a customer settling a sales transaction;
an input unit to receive selections from the customer related to the settling of the sales transaction;
a transaction code reader configured to receive a transaction code related to the sales transaction;
a communication interface for receiving information related to the sales transaction from a store server based on the transaction code received by the transaction code reader; and
a processor configured to:
cause a first screen to be displayed on the display screen requesting the customer to declare an intention or not to use a privileged payment method for settling the sales transaction,
cause a second screen to be displayed on the display screen after receiving the declaration via the first screen, the second screen instructing the customer to use the transaction code reader to enter the transaction code,
if the customer declared an intention to use the privileged payment method via the first screen, control the communication interface to send the transaction code along with a privilege present indication to the store server,
if the customer declared an intention not to use the privileged payment method via the first screen, control the communication interface to send the transaction code to the store server,
cause a third screen to be displayed on the display screen showing transaction information associated with the transaction code sent to the store server and a transaction amount due calculated by the store server for the sales transaction, and
cause a fourth screen to be displayed on the display screen if a checkout button on third screen is operated, the fourth screen including payment method options for settling of the sales transaction, wherein
the fourth screen permits only the privileged payment method to be selected by the customer for settling of the sales transaction if the privilege present indication was sent along with the transaction code to the store server, and
the fourth screen permits any one of the payment method options to be selected by the customer for settling the sales transaction if the privilege present indication was not sent along with the transaction code to the store server.

7. The checkout apparatus according to claim 6, wherein the fourth screen includes icons for payments options other than the privileged payment method that are grayed out if the privilege present indication was sent along with the transaction code.

8. The checkout apparatus according to claim 6, wherein the processor is configured to cause the display screen to display an error message if any other payment option other than the privileged payment method is selected on the fourth screen when the privilege present indication was sent along with the transaction code.

9. The checkout apparatus according to claim 6, wherein the transaction code reader is a scanner.

10. The checkout apparatus according to claim 6, wherein the input unit is a touch panel integrated with the display screen.

11. The checkout apparatus according to claim 6, wherein the privileged payment method is payment via a store credit card.

12. The checkout apparatus according to claim 6, wherein the privileged payment method is payment via a prepaid electronic money card.

13. A non-transitory, computer-readable medium storing program instructions which when executed by a checkout apparatus cause the checkout apparatus to perform a method comprising:
causing a display unit to display a selection screen on which a payment method can be selected from a plurality of payment methods; and
receiving privilege presence information from an input unit, the privilege presence information indicating whether or not a customer intends to pay with a specific payment method with which a privilege is associated, wherein
if the received privilege presence information indicates the customer intends to pay with the specific payment method, the selection screen permits only the specific payment method to be selected.

14. The non-transitory, computer-readable medium according to claim 13, wherein icons for payments methods other than the specific payment method are grayed out on the selection screen when the received privilege presence information indicates the customer intends to pay with the specific payment method.

15. The non-transitory, computer-readable medium according to claim 13, the method further comprising:
causing the display unit to display an error message if the received privilege presence information indicates the customer intends to pay with the specific payment method and any other payment method other than the specific payment method is selected on the selection screen.

16. The non-transitory, computer-readable medium according to claim 13, wherein
the input unit is a scanner, and
the privilege presence information is provided via the scanner scanning a code.

17. The non-transitory, computer-readable medium according to claim 13, wherein
the input unit is a touch panel integrated with the display unit.

18. The non-transitory, computer-readable medium according to claim 17, the method further comprising:
displaying a privileged payment method intention screen on the display unit before the selection screen, wherein
the customer provides the privilege presence information via the touch panel while the privileged payment method intention screen is displayed.

19. The non-transitory, computer-readable medium according to claim 18, wherein the specific payment method is payment made via a store credit card.

20. The non-transitory, computer-readable medium according to claim 18, wherein the specific payment method is payment made via a prepaid electronic money card.
